(19) United States
(12) Patent Application Publication
(10) Pub. No.: US 2022/0037911 A1
(43) Pub. Date: Feb. 3, 2022

(54) MULTIFUNCTIONAL MOBILE POWER DEVICE

(71) Applicant: Shanghai Power Station Co., Ltd., Shanghai (CN)

(72) Inventors: Yuanjun YE, Shanghai (CN); Yezhan WANG, Shanghai (CN); Rui TANG, Shanghai (CN); Shengshang XU, Shanghai (CN)

(73) Assignee: Shanghai Power Station Co., Ltd.

(21) Appl. No.: 16/945,436

(22) Filed: Jul. 31, 2020

(51) Int. Cl. H02J 7/34; H02J 7/00; H02J 7/02

(52) U.S. Cl. CPC H02J 7/342; H02J 7/007182; H02J 7/02; H02J 7/0034

(57) ABSTRACT

A power device includes a power conversion module connectable to an external power supply, a charging module capable of charging an external battery, a charge storage module capable of providing a current to start up an external device, and a control module configured to control the start-up of the external device when the power device is not connected to the external power supply.

### FIELD OF THE DISCLOSURE

The present invention relates to a power device and more particularly to a multifunctional power device that may, among other things, charge a battery and/or start up an external device (such as an engine).

### BACKGROUND

In general, an output from a conventional battery charger is used primarily for charging a battery. The charger is incapable of providing an instant output of a large current to start up an automobile when the battery of the automobile suffers from insufficient voltage or damage.

### SUMMARY

One embodiment of the present disclosure provides a power device including a power conversion module connectable to an external power supply, a charging module capable of charging an external battery, a charge storage module capable of providing a current to start up an external device, and a control module configured to control the start-up of the external device when the power device is not connected to the external power supply.

Another embodiment of the present disclosure provides a method of a power device. The method includes receiving a command to start up an external device, detecting whether the power device is connected to an external power supply, and controlling the start-up of the external device based on the detection.

### BRIEF DESCRIPTION OF THE DRAWINGS

FIG. 1 is a block diagram of a multifunctional portable power device consistent with an exemplary embodiment of the present disclosure.

FIG. 2A is a circuit diagram of an internal charging module consistent with an exemplary embodiment of the present disclosure.

FIG. 2B is a circuit diagram of a charge storage module consistent with an exemplary embodiment of the present disclosure.

FIG. 2C is a circuit diagram of a start-up module consistent with an exemplary embodiment of the present disclosure.

FIG. 3 is flowchart of a process performed by a power device when operating in a charging mode consistent with an embodiment of the present disclosure.

FIG. 4 is flowchart of a process performed by a power device when operating in a portable start-up mode consistent with an embodiment of the present disclosure.

FIG. 5 is flowchart of a process performed by a power device when operating in an assisted start-up mode consistent with an embodiment of the present disclosure.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

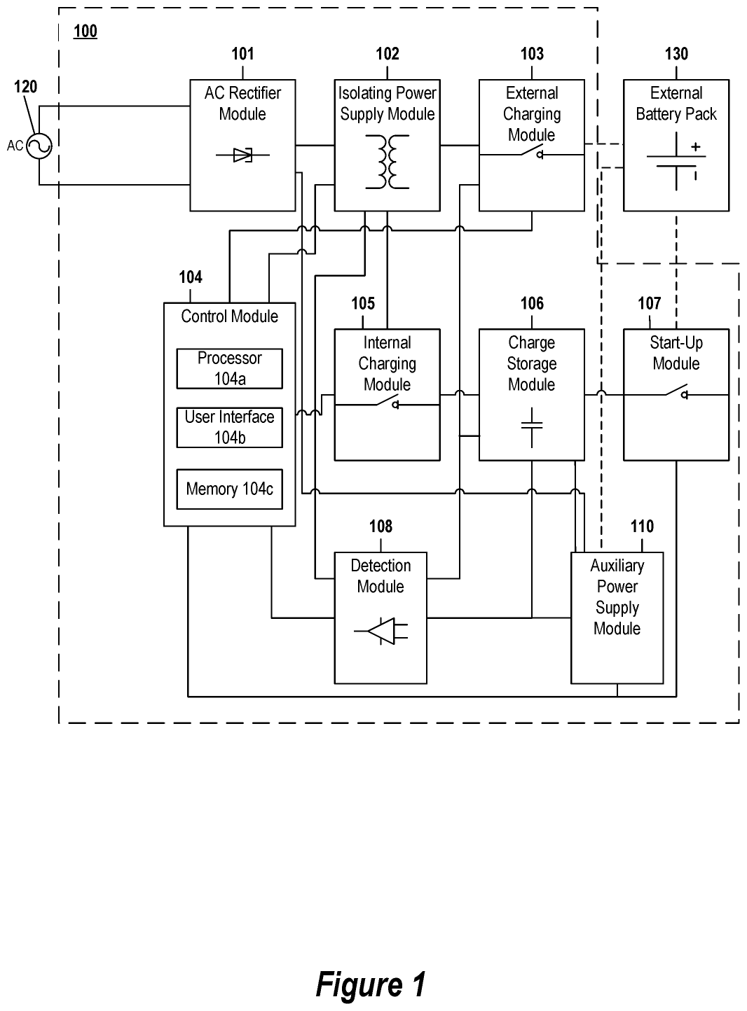

FIG. 1 is a block diagram of a multifunctional power device 100, consistent with an exemplary embodiment of the present disclosure. In the exemplary embodiment illustrated in FIG. 1, the multifunctional power device 100 may include power conversion module, which may include an alternating current (AC) rectifier module 101 and/or an isolating power supply module 102. The power device 100 also includes an external charging module 103, a control module 104, an internal charging module 105, a charge storage module 106, a start-up module 107, a detection module 108, and an auxiliary power supply module 110. The power device 100 may be connectable to an AC source 120 and/or an external battery pack 130 positioned within an external device, such as a vehicle including an automobile, airplane, utility vehicle, watercraft, etc.

The AC rectifier module 101 may be configured to convert an input AC voltage provided by the AC source 120 into a direct current (DC) voltage (also referred to as “first DC voltage”) that is provided to the isolating power supply module 102 and the auxiliary power supply module 110. The AC rectifier module 101 may also smooth the rectified DC voltage before it is output. The isolating power supply module 102 may be coupled to the received DC voltage and output a safe, low-voltage DC voltage (also referred to as “second DC voltage”) to the external charging module 103, the internal charging module 105, and/or the control module 104. The external charging module 103 may be configured to receive the low-voltage DC voltage and, in response to an external charging control signal provided from control module 104, charge the external battery pack 130 of the external device. The internal charging module 105 may be configured to receive the low-voltage DC voltage and, in response to an internal charging control signal provided from the control module 104, charge the charge storage module 106. The start-up module 107 may be configured to, in response to a start-up control signal provided from the control module 104, couple the charge storage module 106 to the external battery pack 130, to provide a large current necessary for starting an engine coupled to the external battery pack 130. The detection module 108 may be configured to detect a status of the external battery pack 130 and/or the charge storage module 106. The auxiliary power supply module 110 may be configured to, when the power device 100 is disconnected from the AC source 120 and is connected to the external battery pack 130, supply the electrical power from the external battery pack 130 to the internal components of the power device 100.

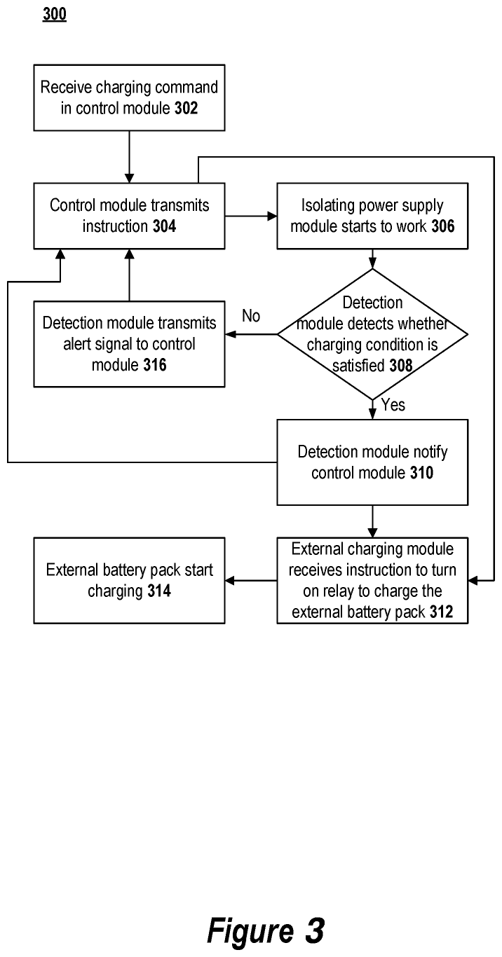

The control module 104 may include a processor 104a, a user interface 104b, and a memory 104c. The processor 104a can be one or more processing devices, such as a central processing unit (CPU), which executes program instructions to perform various functions, such as the processes described in more detail below with respect to FIGS. 3, 4, and 5. In some embodiments, the control module 104 may be implemented by a single chip microcomputer.

The user interface 104b may include components configured to receive user inputs and provide information to a user. For example, the user interface 104b may include a display, a microphone, a speaker, a keyboard, a mouse, a track pad, a button, a dial, a knob, a printer, a light, an LED, a haptic feedback device, a touchscreen and/or other input or output devices. The user interface 104b may be physically located on the power device 100 or may remotely connect to the components within the power device 100 via a wired or wireless network. In some embodiments, the user interface 104b may include components (e.g., a keyboard, a mouse, a track pad, buttons, a knob, touchscreen, etc.) through which a user may provide various commands representing various operation modes in which the power device 100 may operate. The various commands may include a charging command representing a charging mode, a wired start-up command, a portable start-up command, a detection command, and an assisted start-up command representing an assisted start-up mode.

The memory 104c may be a volatile or non-volatile, magnetic, semiconductor, optical, removable, non-removable, or other type of storage device or tangible (i.e., non-transitory) computer-readable medium, consistent with disclosed embodiments. The memory 104c may store one or more programs (e.g., modules, code, scripts, or functions) executed by the processor 104a to perform methods consistent with disclosed embodiments. The programs may include operating systems (not shown) that perform known operating system functions when executed by one or more processors. Disclosed embodiments may operate and function with computer systems running any type of operating system. The programs may be written in one or more programming or scripting languages. One or more of such software sections or modules of the memory 104c may be integrated into a computer system, non-transitory computer-readable media, or existing communications software. The programs may also be implemented or replicated as firmware or circuit logic.

The power device 100 may detect, via the detection module 108, the status of the external battery and, through the user interface, communicate the detected status to the user.

When the control module 104 receives a command (e.g., the charging command, the wired start-up command, the portable start-up command, or the assisted start-up command, etc.) through the user interface 104b, it transmits a corresponding control signal to the external charging module 103 or the internal charging module 105 to charge the external battery pack 130 or the charge storage module 106, respectively.

When the control module 104 receives a charging command through the user interface 104b, it transmits an external charging signal to the external charging module 103. In response to the external charging signal, the external charging module 103 will turn on to charge the external battery pack 130. The detection module 108 monitors the charging process and transmits a feedback signal to the control module 104 to control charging parameters such as current and voltage.

When the control module 104 receives a wired start-up command through the user interface 104b, it transmits an internal charging signal to the internal charging module 105. The internal charging module 105 will charge the charge storage module 106. When the charging of the charge storage module 106 is completed, the detection module 108 transmits a feedback signal to the control module 104. Once the control module 104 receives the feedback signal, the control module 104 will control the internal charging module 105 to maintain the charging of the charge storage module 106 and transmit a start-up control signal to the start-up module 107 to control an output of a large current to the external battery pack 130 so as to assist the start-up of the external device. Because the AC power is consistently supplied, the voltage across the charge storage module 106 does not drop.

The charge storage module 106 is adapted to charge and discharge rapidly. As an example, the charge storage module 106 comprises one or more capacitors with a total capacitance of approximately 200 F to 300 F, capable of providing a large current to an external battery pack 130 to assist the start-up of the external device.

The wired start-up mode may be used when the power device 100 is connected to the AC source 120 as described above. Alternatively, the power device 100 may be disconnected from the AC source 120 and operate in a portable mode, after the charge storage module 106 is fully charged. When the charge storage module 106 is fully charged, the large amount of charges stored therein provide power to components of the power device 100 (e.g., the control module 104, the internal charging module 105, detection module 108, etc.), and may also provide a large current to the external battery pack 130 to assist with a high-current start-up of the external device and/or to charge the external battery pack 130 of the external device. In order to provide a current that is sufficiently large to start up the external device, the charge storage module 106 may include even larger capacitors, with a total capacitance of approximately equal to or more than 200 F, for example, 300 F to 600 F, depending on storage time required of the charge storage module 106.

In an assistant start-up mode, the residual power of the external battery pack 130 can be used to reversely charge the charge storage module 106 without power supplied from the AC source 120. Because of the high charge density of the charge storage module 106, for example, the capacitors with large capacitance, as long as the external battery pack 130 has a voltage above 12V, the remaining power of the external battery pack 130 may be sufficient to reversely charge the charge storage module 106. Once charged, the charge storage module 106 may provide instantaneous high current to assist start-up of an external device.

As described above, the power device 100 may be used to assist the normal start-up of the external device in case where the external battery pack of the external device suffers from undervoltage or damage.

The start-up commands, i.e., the wired, portable, and assisted start-up commands, may be issued in response to user input. In other words, the user may dictate whether the power device 100 should start up the external device in the wired mode when provided with the AC power source, or in the portable mode when the power device 100 is not plugged into an AC power source, or in the assisted start-up mode when no AC power source is connected and the internal charge storage module is not sufficiently charged. Alternatively, the power device 100 may be configured such that the user may be agnostic of which mode the power device 100 should operate in. In other words, the user may simply prompt the power device 100 to start up a connected device through the user interface 104b. The control module 104, maybe in combination with other components of the power device 100, determines whether the power device should start up the device in the wired mode, portable mode, or assisted mode.

Furthermore, the power device 100 may be connected to both an external battery and a separate external device at the same time. The external battery may be connected to the external charging module and may be charged by the power device 100 as needed. The external device may be started by the power device 100 as needed. In this scenario, the assisted start-up of the device may be through the assistance of the external battery or a battery within the external device.

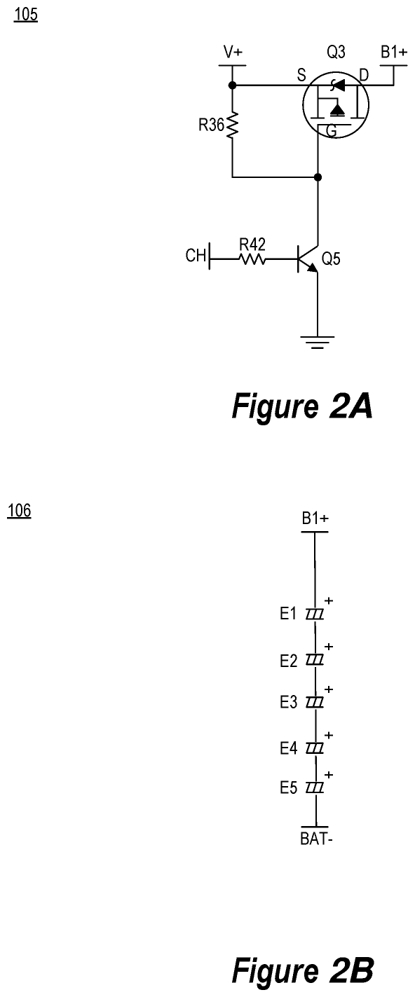

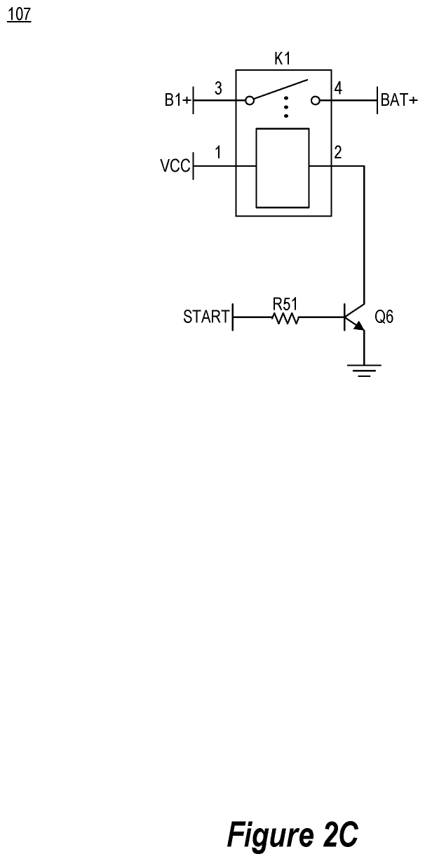

FIGS. 2A-2C are circuit diagram of various components of the power device 100, consistent with an exemplary embodiment of the present disclosure. Specifically, FIG. 2A is a circuit diagram of the internal charging module 105, consistent with an exemplary embodiment of the present disclosure. FIG. 2B is a circuit diagram of the charge storage module 106, consistent with an exemplary embodiment of the present disclosure. FIG. 2C is a circuit diagram of the start-up module 107, consistent with an exemplary embodiment of the present disclosure.

As illustrated in FIG. 2A, in the internal charging module 105, one end of a resistor R42 is connected to a signal end of the control module 104. The other end of the resistor R42 is connected to the base of a bipolar junction transistor (BJT) Q5. The emitter of the BJT Q5 is connected to the ground. The collector of the BJT Q5 is connected to one end of the resistor R36 and the gate of the field-effect transistor Q3. Both the source of the field-effect transistor Q3 and the other end of the resistor R36 are connected to a power source input end V+ of the isolating power supply module 102. The drain of the field-effect transistor Q3 is connected to a positive electrode B1+ of a capacitor E1 of the charge storage module 106.

As illustrated in FIG. 2B, in the charge storage module 106, capacitors E1-E5 are serially connected between the positive electrode B1+ and a negative output end BAT−. The number of capacitors may depend on the application.

As illustrated in FIG. 2C, in the start-up module 107, one end of a resistor R51 is connected to the signal end (“START”) of the control module 104. The other end of the resistor R51 is connected to the base of a BJT Q6. The emitter of the BJT Q6 is connected to the ground. The collector of the BJT Q6 is connected to a pin 2 of relay K1. A pin 1 of the relay K1 is connected to a power source Vcc. A pin 3 of the relay K1 is connected to the positive electrode B1+ of the capacitor E1. A pin 4 of the relay K1 is connected to a positive output terminal BAT+.

During operation, in the internal charging module 105, an internal charging control signal CH (FIG. 2A) from the control module 104 passes through the resistor R42 to turn on the BJT Q5. The BJT Q5 reduces the gate voltage of the field-effect transistor Q3, which is a P-type field-effect transistor. When the gate voltage of the field-effect transistor Q3 is low, the drain-source path is conductive. Therefore, the voltage V+ of the isolating power supply module 102 will rapidly charge the charge storage module 106 through the field-effect transistor Q3.

In the charge storage module 106, a plurality of capacitors are connected in series to provide a voltage suitable for use. The serial connection of the plurality of capacitors E1 through E5 may increase the voltage. Before supplying power for start-up, the capacitors E1 through E5 are charged by the internal charging module 105. The capacitors E1 through E5 are capable of rapid charging and discharging. The capacitors E1 through E5 have very low resistance and high power density and thus are capable of suddenly releasing a high jump current in an instant. Additionally, the capacitors E1 through E5 can store energy within a short period of time, thus enabling its portable and mobile use without the AC supply. After the capacitors E1 through E5 are charged, they can be used to charge the external battery pack 130, or provide power to the external battery pack 130 to assist in starting-up of the external device containing the external battery pack 130.

A start-up signal START of the control module 104 causes the BJT Q6 to be conductive by means of the resistor R51. The conductive BJT Q6 may cause the relay K1 to pull in, and then the stored charges in the charge storage module 106 are provided through the relay K1 to the external battery pack 130 so as to assist starting up of an engine coupled to the external battery pack 130.

FIG. 3 is flowchart of a process 300 performed by the power device 100 when operating in a charging mode, consistent with an embodiment of the present disclosure. In the charging mode, the power device 100 is connected to the AC source 120 and the external battery pack 130 of the external device.

As shown in FIG. 3, at step 302, the control module 104 may receive the charging command to operate the power device 100 in the charging mode via a control panel (i.e., the user interface 104b) provided in the power device 100. The command may be input by a user via a button on the control panel. At step 304, the control module 104 may transmit a control signal to the isolating power supply module 102 to instruct the isolating power supply module 102 to start working. At step 306, upon receiving the control signal from the control module 104, the isolating power supply module 102 starts and converts a DC voltage into a low-voltage DC voltage and may transmit the low-voltage DC current to external charging module 103. At step 308, the detection module 108 may monitor the status of the external battery pack 130 of the external device to determine whether the status of the external battery pack 130 satisfies a charging condition. For example, the detection module 108 may detect whether the external battery pack 130 is correctly connected with the power device 100 (e.g., the polarity is correct). If the external battery pack 130 is correctly connected with the power device 100, the detection module 108 may determine that the charging condition is satisfied. If the detection module 108 determines that the charging condition is satisfied (step 308: Yes), then, at step 310, the detection module 108 may notify the control module 104 that the charging condition is satisfied, such that the control module 104 may transmit the external charging signal to the external charging module 103. At step 312, upon receiving the external charging signal, the external charging module 103 may turn on a relay to start charging the external battery pack 130 of the external device. As a result, at step 314, the power device 100 may start charging the external battery pack 130. If the detection module 108 determines that the charging condition is not satisfied (step 308: No), then, at step 316, the detection module 108 may transmit an alert signal to the control module 104. Upon receiving the alert signal, the control module 104 may transmit or display a prompt signal via the user interface 104b.

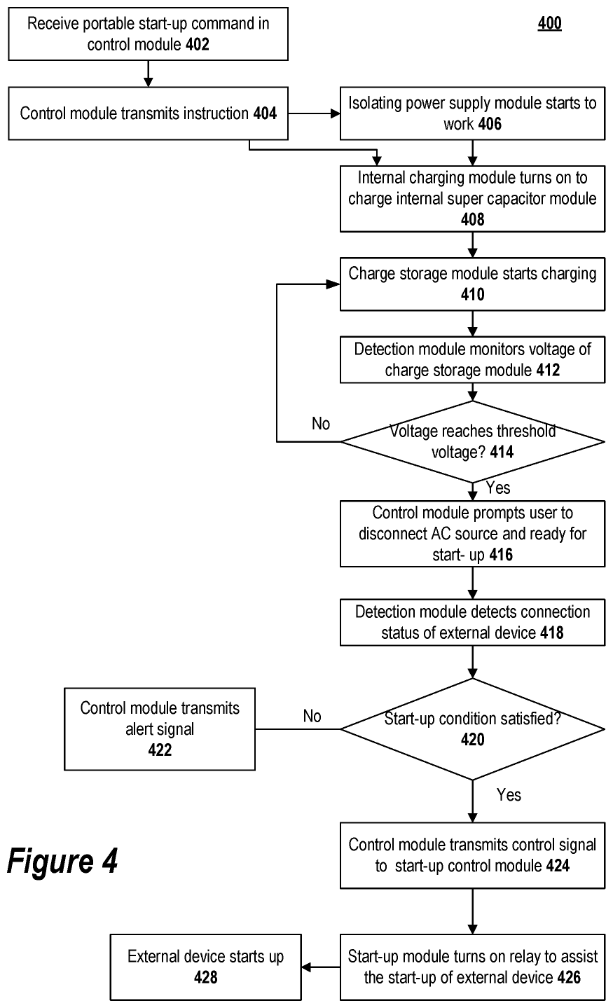

FIG. 4 is flowchart of a process 400 performed by the power device 100 when operating in a portable start-up mode, consistent with an embodiment of the present disclosure.

As shown in FIG. 4, at step 402, the control module 104 may receive a portable start-up command to operate in the portable start-up mode via the control panel provided in the power device 100. The command may be input by the user via a portable start-up button on the control panel. At step 404, the control module 104 may transmit a control signal to the isolating power supply module 102 to instruct the isolating power supply module 102 to start working. The control module 104 may also transmit an internal charging signal to the internal charging module 105. At step 406, upon receiving the control signal from the control module 104, the isolating power supply module 102 may start to work. Specifically, the isolating power supply module 102 may convert a DC voltage into a low-voltage DC voltage and may transmit the low-voltage DC voltage to the internal charging module 105. At step 408, upon receiving the internal charging signal from the control module 104, the internal charging module 105 may turn on and connect the insolating power supply module 102 to the charge storage module 106 to start charging the charge storage module 106. As a result, at step 410, the charge storage module 106 may start charging. At step 412, the detection module 108 may monitor the voltage of the charge storage module 106. At step 414, the detection module 108 may detect whether the voltage of the charge storage module 106 reaches a threshold voltage. For example, the threshold voltage may represent the voltage when the charge storage module 106 is fully charged. When the threshold voltage is reached (step 414: Yes), the detection module 108 may transmit a feedback signal to the control module 104. Upon receiving the feedback signal, at step 416, the control module 104 may transmit a prompt signal via the user interface 104b, prompting the user to disconnect the power device 100 from the AC source 120 and indicating that the power device 100 is ready for starting up an external device. When the threshold voltage is not reached (step 414: No), the process may return to step 410 where the charging of the charge storage module 106 continues.

After the user disconnects the power device 100 from the AC source 120, the control module 104 may control the charge storage module 106 to provide electrical power to various components of the power device 100, such as, for example, the control module 104, the detection module 108, etc.

While the power device 100 is disconnected from the AC source 120, the user may connect the power device 100 to an external battery pack 130 of an external device. Because the charge storage module 106 provides electrical power to the detection module 108, at step 418, the detection module 108 may monitor the connection status of the external battery pack 130 and report the connection status to the control module 104. At step 420, the detection module 108 (or the control module 104) may determine whether the connection status satisfies a start-up condition. For example, the detection module 108 may detect the voltage across the external battery pack 130. If the voltage across the external battery pack 130 is lower than a threshold start-up voltage (e.g., 0.2 V) or is negative (e.g., the external battery back 130 is reversely connected to the power device 100), the detection module 108 may determine that the start-up condition is not satisfied (step 420: No). In this case, at step 422, the detection module 108 may transmit a signal to the control module 104, and the control module 104 may transmits an alert signal to the user.

If the voltage across the external battery pack 130 is equal to or higher than a threshold voltage, the detection module 108 may determine that the start-up condition is satisfied (step 420: Yes). In this case, at step 424, the detection module 108 may transmit a signal to the control module 104 indicating that the start-up condition is satisfied, and the control module 104 may transmit a start-up control signal to the start-up module 107. At step 426, upon receiving the start-up control signal, the start-up module 107 may cause the relay K1 to pull in, such that the amount of electricity in the charge storage module 106 is provided through the relay K1 to the external battery pack 130 of the external device so as to provide a large current to provide an engine start capability to an engine of the external device coupled to the external battery pack 130 in a portable manner. Meanwhile, the control module 104 may transmit a prompt signal to the user to notify the user to start up the engine. The user may then start up the engine (e.g., by turning a key connected to the engine) at step 428.

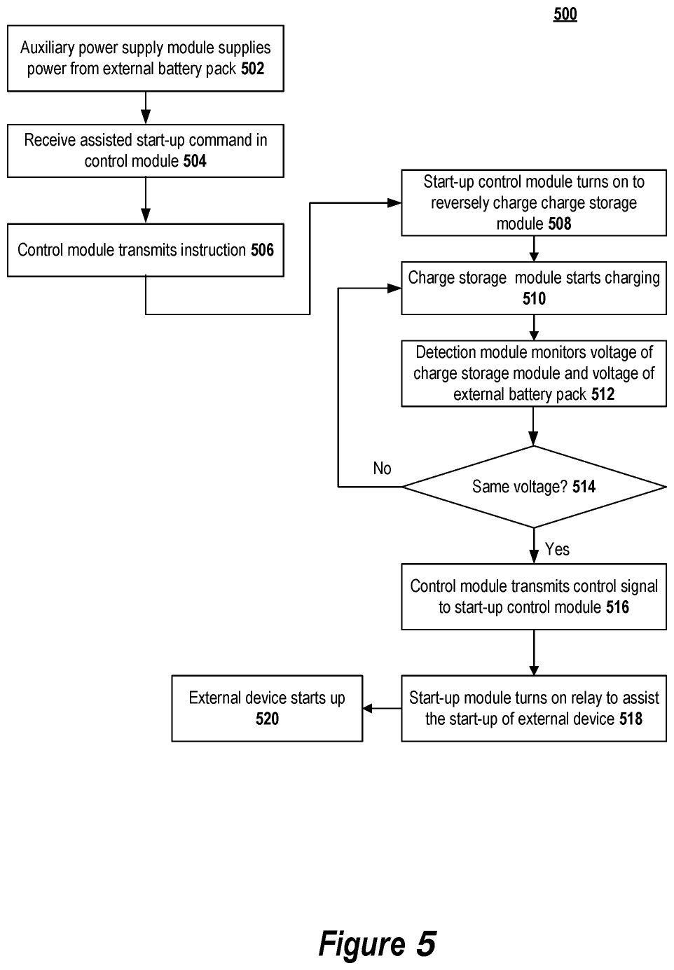

FIG. 5 is flowchart of a process 500 performed by the power device 100 when operating in an assisted start-up mode, consistent with an embodiment of the present disclosure.

Before the process 500 starts, the power device 100 is disconnected from the AC source 120 and is connected to the external battery pack 130. At step 502, the auxiliary power supply module 110 may supply the power from the external battery pack 130 to various components in the power device 100, such as the control module 104 and the detection module 108, etc. As a result, the control module 104 and the detection module 108 may start to work. The detection module 108 may detect the voltage across the external battery pack 130 and determine whether the voltage across the external battery pack 130 is equal to or higher than a threshold voltage (e.g., 12V). If the voltage across the external battery pack 130 is equal to or higher than the threshold voltage, the detection module 108 may transmit a signal to the control module 104, such that the control module 104 may notify the user through the user interface 104b that the power device 100 may operation in an assisted start-up mode. For example, the control module 104 may display a green light on a control panel. After receiving the notification, the user may send an assisted start-up command to the power device 100 via the user interface 104b. Thus, at step 504, the control module 104 may receive the assisted start-up command. At step 506, the control module 104 may transmit a control signal to the start-up module 107 to instruct the start-up module 107 to charge the charge storage module 106. At step 508, upon receiving the control signal from the control module 104, the start-up module 107 may turn on and supply the charges stored in the external battery pack 130 to the charge storage module 106, to reversely charge the charge storage module 106. As a result, at step 510, the charge storage module 106 may start charging.

At step 512, the detection module 108 may monitor the voltage of the charge storage module 106 and the voltage of the external battery pack 130. At step 514, the detection module 108 (or the control module) may detect whether the voltage of the charge storage module 106 is substantially the same as the voltage of the external battery pack. When the voltage of the charge storage module 106 is not the same as the voltage of the external battery pack (step 514: No), the detection module 108 may transmit a feedback signal to the control module 104, such that the control module 104 may control the start-up module 107 to continue the reverse charging of the charge storage module 106.

When the voltage of the charge storage module 106 is substantially the same as the voltage of the external battery pack (step 514: Yes), the detection module 108 may transmit a feedback signal to the control module 104. Upon receiving the feedback signal, at step 516, the control module 104 may transmit a start-up control signal to the start-up module 107 at step 422. At step 518, upon receiving the start-up control signal, the start-up module 107 may cause the relay K1 to pull in, such that the amount of electricity in the charge storage module 106 is provided through the relay K1 to the external battery pack 130 of the external device so as to provide a large current to provide an engine start capability to an engine of the external device coupled to the external battery pack 130. Meanwhile, the control module 104 may transmit a prompt signal to the user to notify the user to start up the engine. When the user starts up the engine (e.g., by turning a key connected to the engine), at step 520, the engine of the external device starts up.

In the embodiment described with respect to FIG. 5, the charge storage module 106 of the power device 100 is charged by the external battery pack 130 of the external device, and the charged charge storage module 106 is used to assist starting up of the external device. However, the present disclosure is not limited thereto. In an alternative embodiment, the charge storage module 106 of the power device 100 may charged by a battery pack of a first external device (e.g., a first automobile), and the charged charge storage module 106 is used to assist starting up of a second external device (i.e., a second automobile).

In the embodiment illustrated in FIG. 2B, the capacitors E1-E5 in the charge storage module 106 are serially connected. However, the number and the connection of the capacitors are not limited to this particular embodiment. That is, the number of capacitors may be adjusted depending on the application. The capacitors may be connected in parallel, or some of the capacitors are connected in series, and some of the capacitors are connected in series. In addition, the charge storage module 106 does not need to be limited to capacitor(s). Any other storage medium capable of storing a large amount of charges can be used, as persons of ordinary skill would appreciate.

In some embodiments, the charge storage module 106 may be configurable in use. For example, the charge storage module 106 may include multiple modes, suitable for use under different circumstances. For example, when the power device 100 is connected to the AC power source, an operation mode may be adopted where only a portion of the charge storage module's capacity is utilized. In contrast, if the power device 100 is not connected to an AC power source, another mode may be implemented where more capacity of the charge storage module is utilized when starting up an external device. The different modes may be configured to use different parts or overlapping parts of the charge storage module and may be switched by either a hardware switch included in the power device 100 or a software switch implemented in the control module 104. In the example of a charge storage module embodied as capacitors, the different modes may be defined based on two separate sets of capacitors or one set of capacitors with a subset. For example, in a first mode, all of the capacitors in the charge storage module 106 may be connected and utilized to provide the stored charges to the external device, and in a second mode only a subset of the capacitors are connected and utilized. The control module 104 switches the charge storage module between the modes, either through software or by controlling the hardware switch. For example, the control module 104 may determine whether the power device 100 is connected to the AC source 120. If the power device 100 is not connected to the AC source 120, the control module 104 may control the charge storage module to operate in a first mode, thereby providing all of the stored charges to the external device. If the power device 100 is connected to the AC source 120, the control module 104 may control the charge storage module to operate in a second mode so that only a subset of the charge storage module's capacity is utilized.

The power device 100 according to the embodiments of the present disclosure may be used in a portable and mobile way without connected to a power source to provide an engine start capability to an engine. The charge storage 106 of the power device 100 may also be reversely charged using the remaining electricity in an external battery pack of the automobile. The power device 100 is convenient, safe to operate, and highly operable. In particular, the power device 100 provides significant assistance to automobile batteries that suffer from undervoltage and damage, in which case the charger is capable of providing a high-current output at any time to assist the automobile's start-up.

In the descriptions above, the power device 100 includes both an internal charging module 105 and an external charging module 103. Alternatively, the power device 100 may include only one charging module that can be switched to charge an external battery pack or the charge storage module 106, as need be, in response to control signals from the control module. In addition, the charge storage module 106 may also be used to charge an external battery, and the charging module may be controlled by the control module to do so.

In addition, even though the power device described above can be portable, it may also be fixedly connected to a device to monitor the status of the device, to charge a battery within the device, or to start up the device as needed. For example, the power device consistent with the embodiments of this disclosure may be incorporated into an automobile, so that it may monitor the status of the battery in the automobile. The charge storage module may be charged by the battery when the automobile is running and may then be used to start up the engine of the automobile when necessary. In another aspect, the power device so incorporated in the automobile may further include a backup battery connected to the external charging module. The backup battery may be charged when the automobile is running and may assist in start-up of the automobile through the power device.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A power device, comprising:
a power conversion module connectable to an external power supply;
a charging module capable of charging an external battery;
a charge storage module capable of providing a current to start up an external device; and
a control module configured to control the start-up of the external device when the power device is not connected to the external power supply.

2. The power device of claim 1, wherein the control module is configured to control an internal charging module to charge the charge storage module.

3. The power device of claim 1, wherein the control module is configured to control the charging module to charge the external battery.

4. The power device of claim 1, wherein the control module is configured to determine whether a start-up condition is satisfied and, when the condition is satisfied, to control a start-up of the external device.

5. The power device of claim 4, where the control module is configured to determine that the start-up condition is satisfied when a voltage of a battery within the external device is higher than a threshold voltage.

6. The power device of claim 1, wherein the control module is configured to control a reverse charging of the charge storage module by an external battery.

7. The power device of claim 1, wherein the charge storage module comprises one or more capacitors with a capacitance of approximately equal to or more than 200 F.

8. The power device of claim 1, wherein the charge storage module has more than one operating mode that utilize different levels of capacity of the charge storage module.

9. The power device of claim 8, wherein the control module is configured to determine a mode the charge storage module should operate in.

10. The power device of claim 9, wherein the control module is configured to control the charge storage module to operate in a first mode when the power device is not connected to the external power supply and to control the charge storage module to operate in a second mode when the power device is connected to the external power supply, wherein more of the charge storage module's capacity is utilized in the first mode than the second mode.

11. The power device of claim 1, where the power conversion module comprises an alternating current (AC) rectifier module to convert an input AC voltage into a first DC voltage and an isolating power supply module configured to convert the first DC voltage into a second and lower DC voltage.

12. The power device of claim 1, further comprising a detection module configured to detect a voltage of the charge storage module and to transmit a signal indicating the detected voltage to the control module.

13. The power device of claim 1, further comprising a detection module configured to detect a status of the external battery, and to transmit the detected status information to the control module.

14. The power device of claim 1, wherein the control module is further configured to control the start-up of the external device when the power device is connected to an external power supply.

15. The power device of claim 1, wherein the control module is further configured to detect at least one of 1) whether the power device is connected to an external power supply, 2) whether the charge storage module has a sufficient amount of charges for starting up the external device, and 3) whether an external battery is in condition to reverse charge the charge storage module, and is configured to control the start-up of the external device based on detected results.

16. The power device of claim 1, wherein the charging module comprises a first charging module for charging an external battery and a second charging module for starting up an external device.

17. The power device of claim 1, further comprising a user interface for displaying information to a user and/or receiving commands or input from the user.

18. A method of a power device, comprising:
receiving a command to start up an external device;
detecting whether the power device is connected to an external power supply; and
controlling the start-up of the external device based on the detection.

19. The method of claim 18, further comprising determining whether a start-up condition is satisfied, wherein controlling the start-up of the external device comprises controlling the start-up when the condition is satisfied.

20. The method of 19, wherein determining the start-up condition comprises determining whether a voltage of a battery in the external device is higher than a threshold voltage.

21. The method of claim 18, further comprising charging a charge storage module.

22. The method of claim 21, wherein controlling the start-up of the external device comprises controlling the charge storage module to provide a current to the external device after the charge storage module has been charged.

23. The method of claim 21, further comprising:
detecting a voltage of the charge storage module; and
transmitting a signal upon detecting that the voltage of the charge storage module reaches the threshold voltage to a control module or a user interface of the power device.

24. The method of claim 21, further comprising determining a voltage of the charge storage module before charging the charge storage module.

25. The method of claim 21, wherein charging the charge storage module comprising charging the charge storage module using an external power supply.

26. The method of claim 21, wherein charging the charge storage module comprising reverse charging the charge storage module using a battery within the external device.

27. The method of claim 18, wherein the charge storage module comprises one or more capacitors with a capacitance of approximately equal to or more than 200 F.

28. The method of claim 21, wherein the charge storage module has more than one operating mode that utilize different levels of capacity of the charge storage module, the method further comprising determining which mode the charge storage module should operate in.

29. The method of claim 28, further comprising:
operating the charge storage module in a first mode when the power device is not connected to the external power supply; and
operating the charge storage module in a second mode when the power device is connected to the external power supply,
wherein more of the charge storage module's capacity is utilized in the first mode than the second mode.

30. The method of claim 18, further comprising:
converting, by an alternating current (AC) rectifier module, an input AC voltage into a first DC voltage; and
converting, by an isolating power supply module, the first DC voltage into a second and lower DC voltage.

31. The method of claim 18, further comprising charging an external battery.

32. The method of claim 26, wherein charging the external battery comprises controlling a charge storage module to charge an external battery.

33. The method of claim 26, wherein charging the external battery comprises charging the external battery using an external power supply.

34. The method of claim 18, further comprising:
detecting a status of the external battery; and
transmitting the detected status information to a control module or a user interface of the power device.

35. The method of claim 19, further comprising:
controlling, by the control module, the charging module to charge the external battery.

36. The method of claim 19, further comprising:
controlling, by the control module, the start-up of the external device when the power device is connected to an external power supply.

37. The method of claim 18, further comprising:
detecting at least one of 1) whether the power device is connected to an external power supply, 2) whether a charge storage module has a sufficient amount of charges for starting up the external device, and 3) whether an external battery is in condition to reverse charge the charge storage module; and
controlling the start-up of the external device based on detected results.

38. The method of claim 18, further comprising:
displaying, by a user interface, information to a user; and/or
receiving, by the user interface, commands or input from the user.
